(19) United States
(12) Patent Application Publication
(10) Pub. No.: US 2012/0193026 A1
(43) Pub. Date: Aug. 2, 2012

(54) DEVICE FOR PRODUCING CORRUGATED CARDBOARD AND RELATED METHOD

(76) Inventor: Mauro ADAMI, Viareggio (LU) (IT)

(21) Appl. No.: 13/311,684

(22) Filed: Dec. 6, 2011

(30) Foreign Application Priority Data
Dec. 6, 2010 (IT) FI2010A000240

(51) Int. Cl. B32B 37/12; B30B 15/34

(52) U.S. Cl. 156/292; 156/538

(57) ABSTRACT

The machine comprises a series of heated plates (19) arranged according to a longitudinal cardboard advancement direction (FC); above the heated plates, a plurality of pressure members (27; 41, 43, 45), to press the paper sheets against the heated plates (19); between the heated plates (19) and the pressure members (27; 41, 43, 45), an endless flexible contact and advancement element (21), which is pressed by the pressure members (27; 41, 43, 45) against the sheets paper below, said endless flexible element (21) being driven around at least an input guide member (23) and at least an output guide member (25). The input guide member (23) is positioned above a sliding surface (S) of the corrugated cardboard at a distance therefrom such that said paper sheets (F1, F2, F3) are pressed together between said sliding surface (S) and the endless flexible element (21) at said input guide member (23).

### TECHNICAL FIELD

The present invention relates to the field of corrugated cardboard manufacturing. More in particular, the present invention relates to improvements to machines for bonding one or more paper sheets, at least one of which is composed of two sheets, one corrugated and one smooth. Machines of this type are known in the corrugated cardboard production sector and are called “double facers” or “hot platens”.

### STATE OF THE ART

Corrugated cardboard is typically constituted by a plurality of paper sheets glued together, at least one of which is corrugated and at least two of which, forming the outermost layers, are smooth. These smooth outer sheets are called “liners”. The simplest form of corrugated cardboard comprises two smooth sheets, or liners, between which a sheet of corrugated paper is glued. Corrugated cardboard can also comprise a larger number of sheets, with two or more sheets of corrugated paper separated by sheets of smooth paper and with two smooth outer paper sheets forming the liners. Typically, a generic sheet of corrugated cardboard has N corrugated sheets and N+1 of smooth sheets.

Articles of manufacture of this kind are typically produced through the combined use of one or more corrugating units or machines called “single facers”, in which a sheet of smooth paper is subjected to permanent deformation to transform it into a corrugated sheet and joined to a sheet of smooth paper. The composite sheet thus produced is called “single face” in jargon. Arranged downstream of the single facer or single facers is a machine called “double facer”, in which at least one composite sheet, formed by a sheet of corrugated cardboard glued to a sheet of smooth paper, is glued to a liner or outer sheet of smooth paper. According to the type of product to be produced, a plurality of composite sheets, each formed by a smooth sheet and by a corrugated sheet joined by gluing, as well as a smooth sheet forming the outer liner, can be fed to the machine. The various composite sheets (single faces) and the smooth sheet are joined together by gluing.

Typically, a double facer machine for joining paper sheets for producing corrugated cardboard with one or more flutes comprises: a series of heated plates arranged according to a longitudinal cardboard advancement direction; above said heated plates, a plurality of pressure members, to press the paper sheets together and against the heated plates; between the heated plates and the pressure members, an endless flexible contact and advancement element, which is pressed by the pressure members against the paper sheets below, said endless flexible element being driven around at least one input guide member and at least one output guide member.

A machine of this type is described, for example, in U.S. Pat. No. 7,291,243, the content of which is incorporated in the present description.

It has been noted that in conventional double facer machines some problems occur in the area of initial contact between the various paper sheets fed to the input, between the endless flexible element and the heated plates below. These problems cause irregular gluing or gluing defects due to incorrect control of the initial phase of mutual contact between the paper sheets.

In particular, in prior art machines the paper sheets come into mutual contact in points of their advancing trajectory which are not univocally determined. Moreover, frequently the paper sheets that have come into mutual contact, and which therefore have started to adhere, tend to separate and sub sequently join tog ether again. At the moment of initial contact, the adhesive starts to bond the sheets together. When the sheets separate and subsequently come into contact once again, the adhesive is no longer able to join the sheets together in the point in which they became detached. Consequently, the finished product has areas which are not glued or with insufficient glue in the points in which contact fluctuations occurred, i.e. in which the sheets, after having touched initially, were separated and subsequently joined together again.

EP-A-412255 and U.S. Pat. No. 4,764,236 describe double-facers in which a composite sheet formed by a smooth sheet and a corrugated sheet is driven around the input guide roller of the belt which advances the cardboard on the heated plates. A second smooth sheet is fed from below. The point of initial contact between these two components of the corrugated cardboard remains indeterminate and, among other things, depends on the total thickness of the various sheets. This thickness can depend not only on the number of sheets used and therefore on the number of flutes of the cardboard, but also on the actual thickness of each sheet and on the shape of the flutes. There may also be fluctuations in thickness within a same processing order. In a configuration such as described in EP-A-412255 or in U.S. Pat. No. 4,764,236 this causes a continuous shift of the point of initial contact between the sheets to which adhesive has been applied and potential subsequent detachments before the sheets reach the actual gluing space, defined between the heated plates and the pressure members above.

DE-2108378 and DE-1957270 describe double facers in which all the sheets forming the corrugated cardboard are brought into mutual contact upstream of the guide member of the flexible element and of the heated plates below. In particular, DE-1957270 describes an auxiliary roller upstream of the flexible element and of the hot plates. All the sheets which form the corrugated cardboard are guided around this auxiliary roller. Therefore, mutual contact between the sheets starts at this auxiliary roller. No pressure system is provided between the roller and the heated plates. Consequently, while being fed between the auxiliary roller and the heated plates the sheets can be subjected to accidental detachment, i.e. they can be separated from one another, even for a very brief instant and even only along a single corrugation of the intermediate corrugated sheet. A gluing defect occurs in the point of detachment, as the adhesive is no longer able to bond adequately after separation of the sheets, albeit for a brief instant, after initial mutual contact. As the sheets are fed at a speed of a few hundreds of meters per minute, the dynamic stresses and vibrations generated are such as to frequently and easily cause these accidental detachments.

### SUMMARY OF THE INVENTION

According to one aspect, the invention proposes a double-facer machine, i.e. a unit with hot platens, which totally or partly overcomes the aforesaid problems. The object of an embodiment of the invention is to provide a machine that allows improved control of the step of initial mutual contact between paper sheets fed into the machine.

Substantially, according to an embodiment, in a double facer machine of the type defined above, it is provided that the input guide member is positioned above a sliding surface of the cardboard at a distance from said sliding surface such that the paper sheets are pressed together between the sliding surface and the endless flexible element at the input guide member. In substance, the input guide member constitutes the element below which the various paper sheets to be glued together to form the corrugated cardboard are brought into mutual contact. The distance between the surface of the input guide member and the sliding surface of the paper sheets is therefore substantially equal to the thickness of the endless flexible element added to the total thickness of the paper sheets to be glued. For this purpose, the input guide member can advantageously be movable to move towards and away from the sliding surface below, to adapt the position of the guide member to the overall thickness of the paper sheets fed between it and the sliding surface.

The input guide member is in substance the organ that defines the point farthest upstream (with respect to the direction of advancement of the paper sheets forming the corrugated cardboard) of the closed trajectory of the endless flexible element. Two branches of the endless flexible element converge on this input guide member: the upper return branch and the lower active branch, i.e. the branch in contact with the paper sheets below and which transmits thereto, in addition to the gluing pressure, also a driving force to facilitate advancement of the corrugated cardboard.

In substance, the input guide member defines the input point of an advancement space for the corrugated cardboard, said space being delimited between the endless flexible element and the sliding surface of the cardboard. In said space the sheets are pressed against one another and against the sliding surface below, which is advantageously at least partly formed by the heated plates.

In some advantageous embodiments of the invention, upstream of the input guide member there are arranged guiding elements for the paper sheets, which define a plurality of trajectories for advancing the paper sheets to be bonded. Preferably, the guiding elements, the sliding surface and the input guide member are arranged in such a manner that said paper sheets are brought into mutual contact in the area of minimum distance between the input guide member and the sliding surface, while they remain spaced apart upstream of this area of minimum distance. In this way, it is very easy to control the first step of mutual contact between the paper sheets, such that the paper sheets to which an adhesive has been applied up stream of the endless flexible member, and which must be brought into mutual contact to be glued, all come into contact substantially in the same area, and therefore at the same instant, avoiding accidental contact upstream of this area and avoiding also accidental detachment, albeit temporary, downstream of this area. In other words, this arrangement makes it easy to obtain an operation in which the paper sheets to which the adhesive has been applied come into contact with the sheets to be glued in a specific and well-defined point or area, and once this contact has been obtained, the sheets remain attached. The adhesive remains between opposed sheets and starts to migrate towards the inside of the cellulose fibers forming the paper and to be heated, obtaining effective and uniform gluing on all the gluing lines, i.e. on all the flute tips of the sheets of corrugated paper of the single faces, i.e. of the composite sheets comprising a smooth sheet and a corrugated sheet joined in a single facer upstream.

Advantageously, at least one lightening system can be associated with the input guide member, to discharge at least a part of the weight of the input guide member and reduce the force with which said input guide member presses on the paper sheets below.

Advantageously, the input guide member can comprise or can be constituted by an input guide roller, with an axis of rotation oriented substantially at 90° with respect to the longitudinal advancement direction of the paper sheets and therefore of the corrugated cardboard. This guide roller can advantageously be supported by an oscillating arm. The oscillating arm is preferably double, to provide a double support for the two opposed ends of the input guide roller. Advantageously, the axis of oscillation of the arm is located upstream of the input guide member with respect to the advancement direction of the corrugated cardboard.

The axis of rotation of the input guide roller and the axis of oscillation of said oscillating arm preferably lie on a geometrical plane oriented approximately according to the bisector of an angle defined by two branches of the endless flexible element tangent to said input guide roller.

Advantageously, the arm that supports the input guide roller also supports a plurality of pressure members acting on the endless flexible element downstream of the input guide member formed or constituted by the input guide roller.

In advantageous embodiments, the sliding surface on which the paper sheets are pressed by the endless flexible member driven around the input guide member is defined by at least one of the heated plates.

In some advantageous embodiments the endless flexible member is driven around the input guide member for an angle of at least 90°, preferably of at least 120° and even more preferably of at least 150°.

According to a different aspect, the invention relates to a method for bonding together by gluing at least a smooth paper sheet and a composite paper sheet, comprising a smooth sheet and a corrugated sheet (single face), comprising the steps of:
advancing the paper sheets along an advancement path in contact with a series of heated plates and an endless flexible contact and advancement element pressed against said paper sheets by a plurality of pressure members above, said endless flexible element being driven around at least an input guide member and an output guide member;
heating said paper sheets and holding them pressed together while advancing them along said advancement path to cause gluing thereof.

According to some advantageous embodiments of the invention, the method is characterized by joining at least two of said paper sheets (one smooth and one composed of a smooth sheet and a corrugated sheet) together by pressing them between the endless flexible element and a sliding surface at said input guide member.

Further advantageous features and embodiments of the machine and of the method according to the invention are set forth in the attached claims and disclosed in the description below.

### BRIEF DESCRIPTION OF THE DRAWINGS

The invention will be better understood by following the description and accompanying drawing, which shows a non-limiting practical embodiment of the invention. More in particular, in the drawing:

FIG. 1 shows the input part of a machine for bonding smooth and corrugated paper sheets, designed according to the prior art;

FIG. 2 shows a schematic side view of the advancement area of the paper sheets and of the initial gluing area of a machine according to the invention;

FIG. 2A shows a schematic side view of the output area of the machine;

FIG. 3 shows an enlargement of the first joining and gluing area of the machine of FIG. 2;

FIG. 4 shows a further enlargement of the initial contact area between the sheets fed to the machine of FIG. 2; and

FIG. 5 shows an enlargement similar to that of FIG. 4 in a modified embodiment.

### DETAILED DESCRIPTION OF EMBODIMENTS OF THE INVENTION

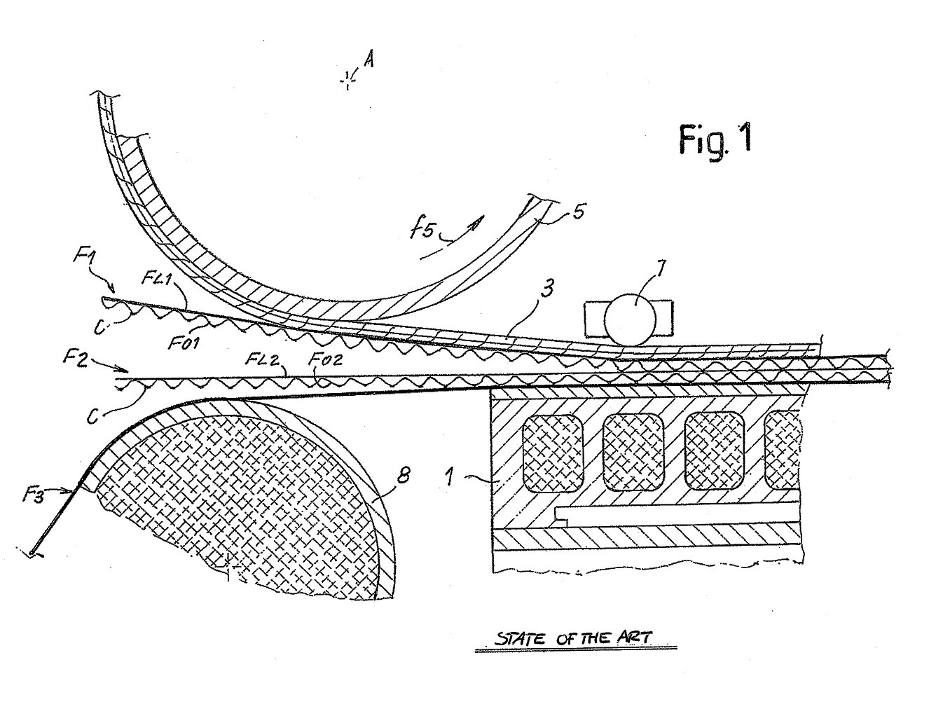

Before illustrating the features of the machine according to the invention, with reference to FIG. 1, the input area of a conventional double facer machine will be illustrated.

Reference number 1 indicates the first heated plate of the machine. Arranged in sequence along the path of the cardboard are a plurality of heated plates 1, sufficient in number to obtain gluing of the paper sheets of which the corrugated cardboard is composed.

Extending above the heated plates 1 is an endless flexible member 3, typically made of felt, mesh or the like, which is driven around an input guide member 5 and around an output guide member (not shown). The input guide member 5 typically comprises a roller or a series of coaxial rollers. It rotates according to the arrow f5 about its axis A. The position of the guide roller 5 with respect to the heated plate 1 below is such that the endless flexible member 3 follows a trajectory convergent towards the heated plate 1 below. In practice, the first segment of the endless flexible member 3 and of the sliding surface of the paper sheets, defined by the sequence of heated plates 1 are mutually convergent in the cardboard advancement direction.

Arranged downstream of the input guide member 5 is a first contact roller 7, typically a dancer roller, which due to its own weight rests on the inner surface of the endless flexible member 3 and presses against said endless flexible member 3, which in turn presses lightly on the paper sheets fed between the endless flexible member 3 and the heated plate 1.

In the example illustrated in FIG. 1, three paper sheets indicated with F1, F2 and F3 are fed to the machine. More in particular, the paper sheet F1 is a composite sheet (single face) formed in turn by a smooth paper sheet FL1 glued to a corrugated paper sheet FO1. The composite sheet F1 was formed in a corrugating unit upstream of the joining machine and not shown, known to those skilled in the art. The sheet F2 is also a single face, composed of a smooth sheet FL2 glued to a second corrugated sheet FO2. The sheet F2 was formed in a corrugating unit, also positioned upstream of the machine illustrated in FIG. 1. Finally, the sheet F3 is formed by a single smooth paper sheet and constitutes one of the two liners of the corrugated cardboard sheet that is produced by the machine, the other liner being represented by the sheet FL1.

Therefore, in this case, the corrugated cardboard produced is a double flute corrugated cardboard. As is known to those skilled in the art, the same machine, suitably adapted or adjusted, can process an assembly of only sheets F2 and F3, to form a single flute corrugated cardboard, or more than three sheets, for example the sheets F1, F2, F3 and a further composite sheet or single face, similar to the composite sheet F1 or F2.

The assembly of sheets F1, F2, F3 advances between the endless flexible member 3 and the series of heated plates 1 to obtain mutual gluing of the sheets F1, F2, F3 by means of an adhesive C applied to the outer flute tips of the sheet FO1 and of the sheet FO2. As is known, since the sheets F1, F2, F3 cannot be pressed with excessive force, which would cause collapse of the flutes formed in the sheets FO1, FO2, using pressure members positioned above the endless flexible member 3 a light pressure is exerted against the endless flexible member 3 and, therefore, against the assembly of the paper sheets F1, F2, F3 which are fed between the endless flexible member 3 and the series of heated plates 1. Heating facilitates drying and setting of the adhesive. The transfer time of the sheets along the path defined between the endless flexible member 3 and the heated plates 1 (determined by the length of the path and by the advancement speed) is such as to maintain the pressure and heating conditions for a time sufficient to allow the adhesive to set. For more effective gluing, the paper sheets F1, F2, F3 (or at least some of them) are preferably pre-heated. FIG. 1 shows a pre-heating roller 8 to heat the smooth sheet F3.

As can be seen in FIG. 1, mutual contact between the various sheets to be glued together on the flute tips of the corrugated sheets FO1 and FO2 takes place downstream of the guide roller 5. More in particular, the sheets F2 and F3 come into contact upstream of or at the beginning of the heated plate 1, while the sheet FO1 comes into contact with the sheet FL2 at the dancer roller 7.

As mentioned in the introductory part of this description, this con figuration causes gluing defects.

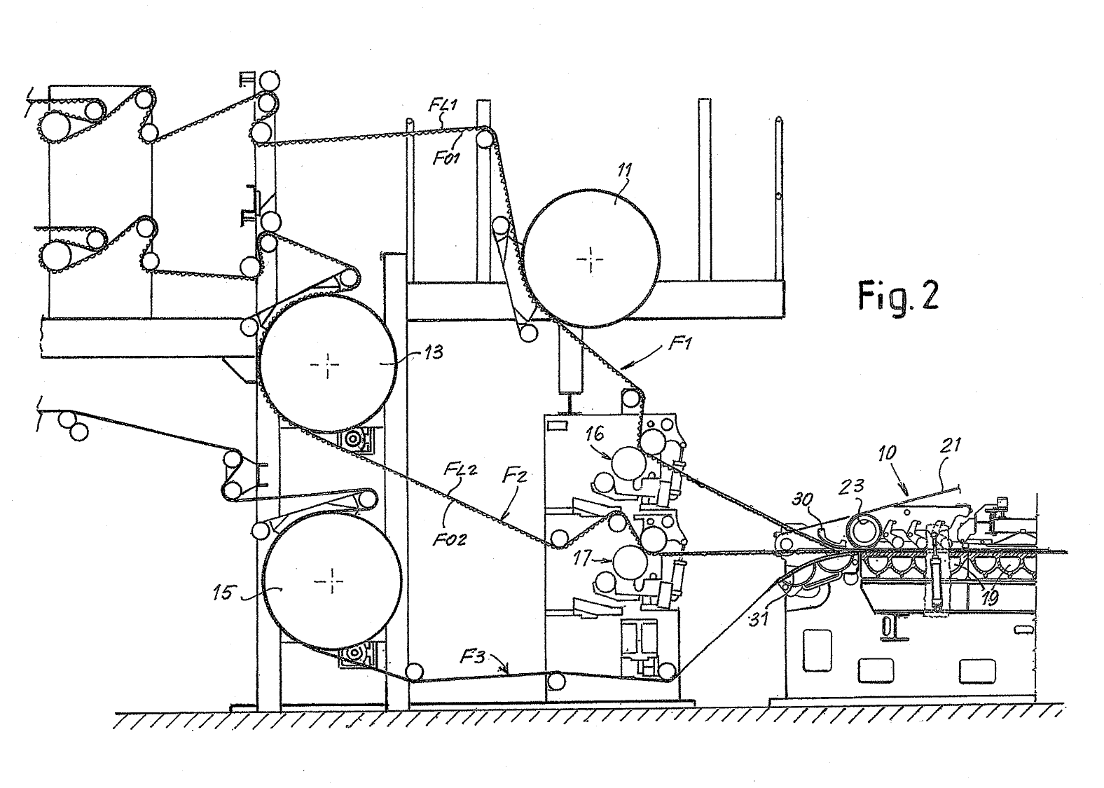

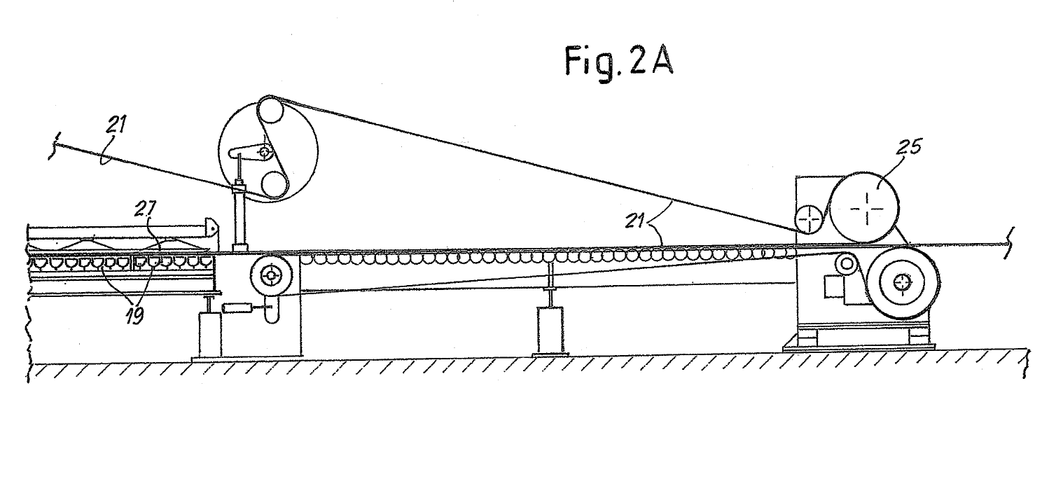

FIG. 2 illustrates the input part of the machine 10 for joining paper sheets according to the invention. FIG. 2A shows the output part of the machine 10.

FIG. 2 illustrates the paths of three sheets F1, F2 and F3 upstream of the machine 10. The sheets F1, F2, F3 come from a line upstream, of known type and not shown. More in particular, the sheets F1 and F2 are fed by respective corrugating units, while the sheet F3 is fed by an unwinder.

It must be understood that the number of three sheets (two “single faces” and a smooth liner) is indicative and that the same machine 10 can process a different number of sheets.

The numerals 11, 13 and 15 indicate the three pre-heating rollers around which the paper sheets F1, F2, F3 are driven. As in FIG. 1, in FIG. 2 the sheet F1 is also a composite sheet formed by a first smooth paper sheet FL1 joined to a corrugated paper sheet FO1, while the sheet F2 is formed by a smooth paper sheet FL2 joined by gluing to a corrugated paper sheet FO2. The sheet F3 is formed by a single smooth paper sheet.

Also arranged upstream of the machine 10 is a first glue applicator 16 to apply adhesive to the flute tips of the corrugated paper sheet FO2, while the numeral 17 indicates a glue applicator to apply adhesive to the flute tips of the corrugated paper sheet FO2.

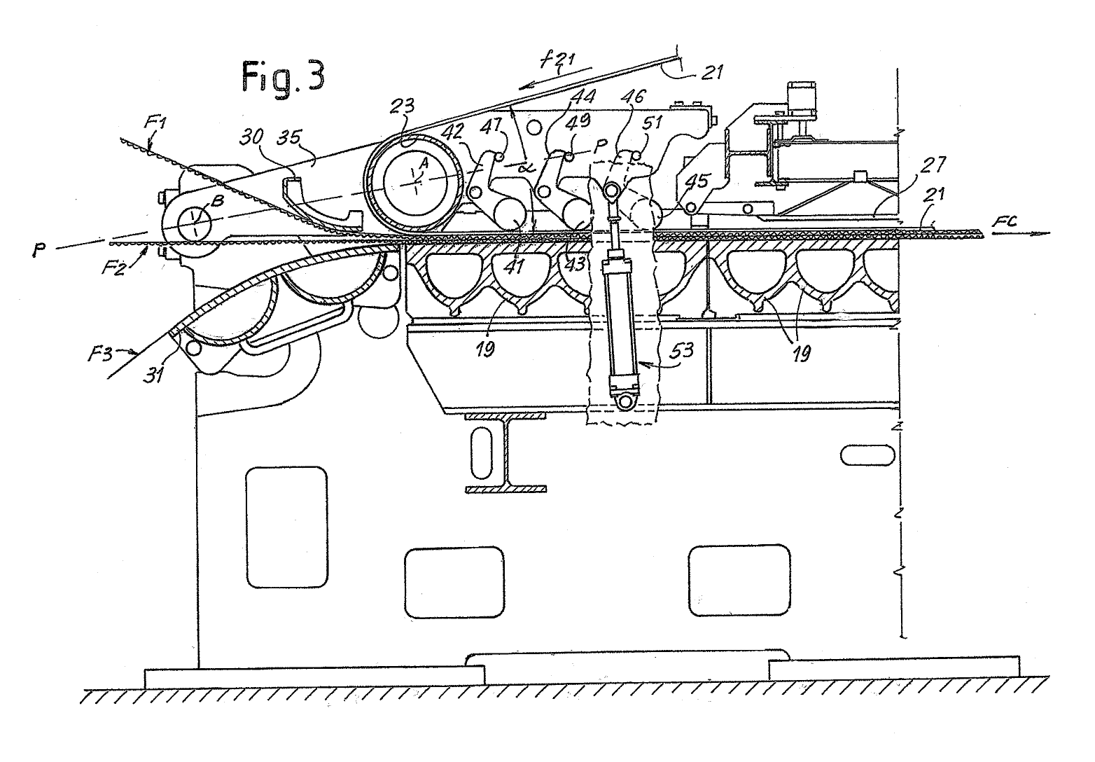

With particular reference to the enlargement of FIG. 3, the three sheets F1, F2 and F3 are fed to the input area of the machine 10 along three distinct paths according to suitable inclinations and the three sheets come into mutual contact simultaneously in the area in which the gluing process is to begin, as described in greater detail below.

The machine 10 comprises a series of heated plates 19 arranged in sequence along the advancement direction FC of the paper sheets forming the corrugated cardboard. Extending above the series of heated plates 19 is an endless flexible member 21 substantially similar to the endless flexible member 3 of FIG. 1. This endless flexible member 21 is driven around an input guide member 23 and around an output guide member 25 (see FIG. 2A).

Arranged along the closed path of the endless flexible member 21 are further guide members, which can make the closed path of the endless flexible member 21 take up a suitable form, which can vary from one machine to another.

Above the lower branch of the endless flexible member 21, which extends parallel to a sliding surface S defined by the upper faces of the heated plates 19, there are arranged known pressure members 27, which can take up various forms known to those skilled in the art. The form of the pressure members 27 is not relevant for the purposes of the present invention. What is of interest is solely that these members do not act directly on the cardboard being advanced along the sequence of heated plates 19, but through the endless flexible member 21. This latter is driven in the movement along its closed trajectory according to the arrow f21 by at least one of the guide rollers, which is appropriately motorized. This facilitates advancement of the cardboard through the machine and also simplifies the initial production operations when the heads of the paper sheets F1, F2, F3 must be guided through the whole extension of the machine.

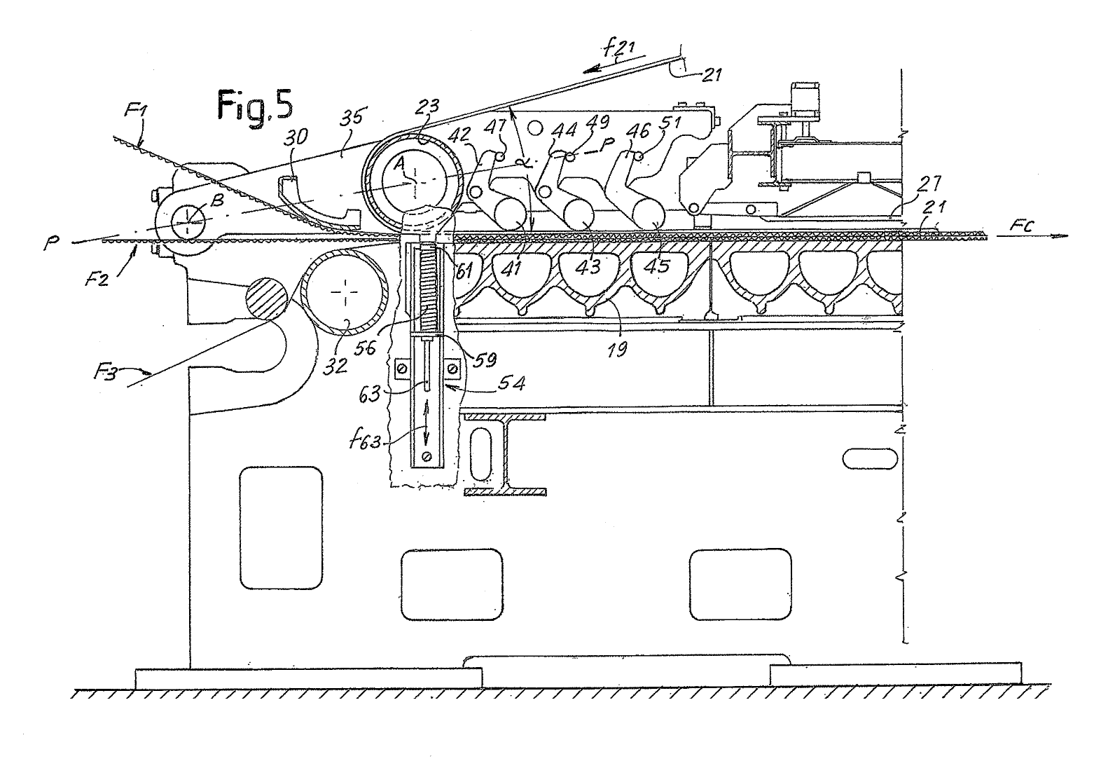

In the example illustrated, a curved guiding surface extends upstream of the sliding surface S formed by the upper faces of the heated plates 19, said curved guiding surface being defined by a plate 31, also heated, along which the smooth paper sheet F3 slides. Alternatively (as will be described below with reference to FIG. 5), a pre-heating roller can be arranged in place of the surface 31, or fixed surfaces and pre-heating rollers can be provide d in combination. The plate 31 also acts as a guiding element for the smooth paper sheet F3, to impart thereto a given input trajectory in the machine. Similar guiding elements are provided for the other composite paper sheets F1 and F2. For example, a convex fixed plate 30 can be provided to guide the sheet F1 and a roller of the gluing unit 17 can be provided to define the trajectory of the sheet F2. The guiding elements can differ from those indicated, also as a function of the number of sheets input. The only thing that is important is that the guiding elements impart a correct trajectory to the various paper sheets, so that these come into mutual contact in the desired point which, as will be clarified below, is defined by the position of the input guide member 23.

In some embodiments, the input guide member 23 comprises an input guide roller rotating about an axis A. In advantageous embodiments, the input guide roller 23 is supported by an oscillating arm 35. Preferably, the oscillating arm 35 is double, i.e. is constituted by two elements associated with the opposed ends of the input guide roller 23 and joined by a torsion bar so as to form a single substantially rigid element to support the input guide roller 23. The double oscillating arm 35 is pivoted about an axis B substantially parallel to the rotation axis A of the input guide roller 23 and substantially orthogonal to the cardboard advancement direction FC along the sliding surface S defined by the upper faces of the heated plates 19.

In some embodiments the axes A and B lie on a plane with the trace P-P (FIG. 3) which is oriented approximately according to the bisector of the angle α (FIG. 3) formed by the two branches of the endless flexible element 21 tangent to the input guide roller 23. In this manner, traction of the endless flexible member 21 does not influence the position of the input guide member 23.

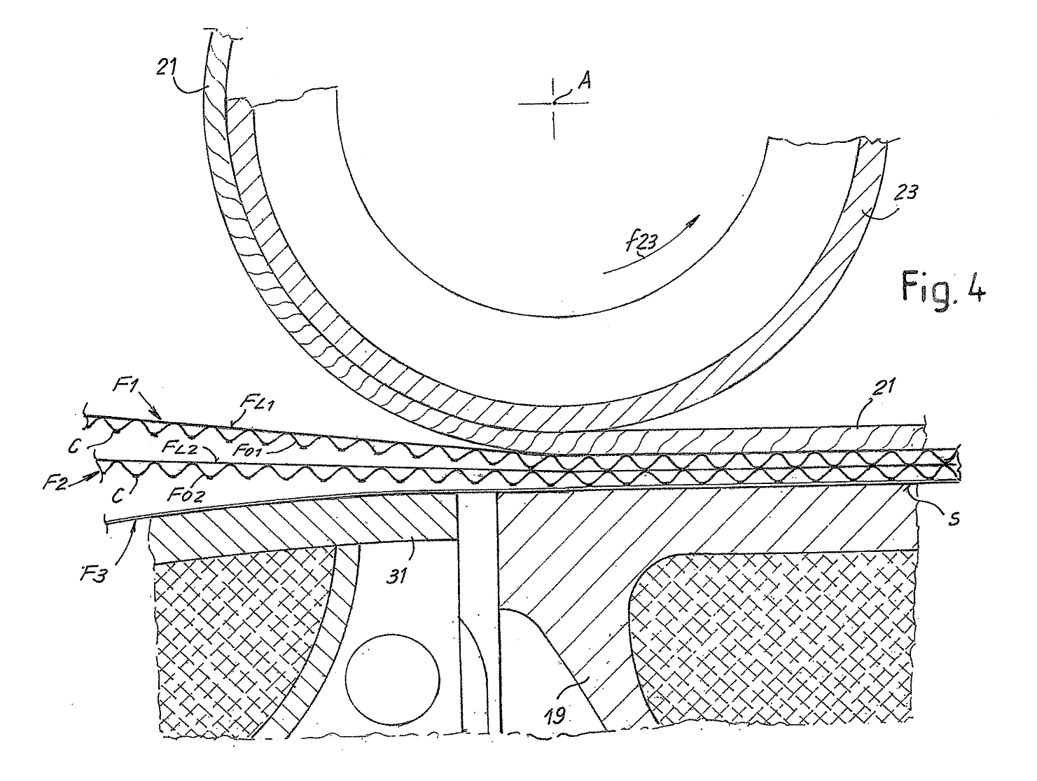

As can be observed in particular in FIG. 4, with respect to the sliding surface S below formed by heated plates 19, the input guide member 23 is positioned in such a manner that the endless flexible member 21 driven around the input guide member 23 presses the paper sheets F1, F2 and F3 together substantially at the vertical plane containing the rotation axis A of the input guide member 23. This ensures that all the sheets come into mutual contact in a specific and univocal point determined by the advancement trajectory. As can be observed in particular in the enlargement of FIG. 4, upstream of the vertical plane containing the axis A, the sheets F1, F2 and F3 are spaced apart from one another by a distance sufficient to prevent mutual contact between the flute tips of the corrugated sheets FO1 and FO2, to which adhesive C has been applied, and the smooth sheets FL2 and F3. This prevents accidental contact and subsequent detachment of the sheets, which would lead to gluing defects. With the arrangement illustrated, the adhesive touches the opposed sheet only in the desired point, which is substantially the same for all the sheets, and downstream of this point contact is maintained without the risk of accidental detachments, due to the substantially rectilinear trajectory of the endless flexible member 21, parallel to the sliding surface S defined by the heated plates 19 below.

In practice, as the product produced by the machine in question, consisting of paper webs or sheets, is subject to variations in thickness and in shape, the point in which mutual contact between the various corrugated paper webs or sheets occurs can in actual fact vary within an interval around the vertical plane passing through the axis of rotation of the guide roller 23. In practice, this point can vary within a space of less than 1 cm and preferably less than 0.5 cm, for example, of approximately 1-2 mm, advantageously of approximately 1 mm along the cardboard advancement path, with respect to the vertical plane passing through the rotation axis of the guide roller 23.

In substance, according to the invention mutual contact between the sheets to be glued takes place at the input guide member 23, rather than downstream thereof. Advantageously, the endless flexible member 21 defines a lower branch substantially parallel to the sliding surf ace S of the paper sheets, which starts in the point of detachment between the endless flexible member 21 and the cylindrical surface of the input guide member 23. This differs substantially with respect to the arrangement of conventional machines (FIG. 1), where the first segment of the endless flexible member 21 converges towards the sliding surface S and only comes into contact with the paper sheet below at a pressure member positioned substantially downstream with respect to the input guide member 23.

With the arrangement according to the invention, it is possible to obtain more regular mutual gluing of the paper sheets.

Downstream of the input guide member 23 there are provided pressure members which push the endless flexible member 21 against the assembly of paper sheets F1, F2, F3 pressing them against the sliding surface S formed by the upper faces of the heated plates 19. In addition to the pressure members 27 these members can comprise also one or more dancer rollers 41, 43 and 45. In some embodiments, such as the one illustrated, the dancer rollers 41, 43, 45 can be mounted idle on respective arms 42, 44 and 46. The arms 42, 44 and 46 can be L-shaped arms, pivoted in an intermediate point to the double oscillating arm 35. A stop 47, 49 and 51 respectively can be provided for each arm to define the maximum lowering position of the rollers 41, 43 and 45. This maximum lowering position is reached when the arm 35 is raised to clean the heated plates 19.

During operation of the machine, the rollers 41, 43 and 45 rest with their weight against the inner surface of the endless flexible member 21 to maintain the paper sheets, which advance between the sliding surface S and the endless flexible member 21, pressed together. It would also be possible to replace, or combine, the rollers 41, 43 and 45 with other pressure members, for example similar to those indicated with 27, for example formed by sliding shoes for the endless flexible member 21 and which, in the example illustrated in FIG. 3, are arranged downstream of the rollers 41, 43 and 45.

The input guide roller 23 is relatively heavy and, if it were to rest with its entire weight on the paper sheets below, in some cases this could cause excessive flattening thereof. In some embodiments, to prevent the input guide roller from pressing with all its weight against the paper sheets, a lightening system can advantageously be provided.

In the example illustrated in FIG. 3 the lightening system 3 comprises one or preferably two pneumatic piston-cylinder actuators 53 placed at the sides of the machine, at the two components forming the double oscillating arm 35. The piston-cylinder actuators 53 can act as pneumatic springs and support a part of the weight of the assembly formed by the double arm 35 and by the input guide roller 23. By adjusting the pressure of the fluid inside the piston-cylinder actuators 53 it is possible to adjust the thrust exerted by the input guide roller 23 against the paper sheets F1, F2, F3 below, so that they are not subjected to excessive pressing, thus avoiding the risk of undesirable flattening of the flutes of the sheets of corrugated paper FO1 and FO2.

FIG. 5 illustrates a modified embodiment of the machine of FIGS. 2, 3 and 4. The same reference numbers indicate parts identical or equivalent to those of the embodiment illustrated in FIGS. 2 to 4. The main difference between FIG. 5 and FIGS. 2 to 4 consists in the fact that the lightening system, indicated in FIG. 5 with 54, comprises an elastic system with helical compression springs 56. Advantageously, two springs 56 can be provided, one on each side of the machine. Only one of these springs is visible in the drawing. The springs 56 provide a thrust on the two parts forming the double oscillating arm 35. The springs 56 are retained between a fixed abutment 59 and a movable abutment 61 integral with a stem 63, which can slide vertically according to the double arrow f63. A respective part of the double arm 35 rests on each head 61 of the two stems 63, so as to discharge part of the weight of the double arm 35 and of the input guide member 23 on the compression spring 56. The lower the position of the input guide roller 23 is, the greater the upward thrust exerted by these springs will be. In substance, this arrangement ensures that the lower the total thickness of the paper sheets located between the endless flexible member 21 and the sliding surface S formed by the heated plates 19 is, the greater the lightening obtained through the compression springs 56 will be. In this way, the weight of the input guide roller 23 on the assembly of paper sheets is adjusted automatically: the lower their thickness, and therefore the lower their resistance to flattening is, the lower the force with which the input guide roller 23 will press against the paper sheets F1, F2, F3 through the endless flexible member 21 will be.

FIG. 5 also shows a modified embodiment of the pre-heating system of the sheet F3 which, in this case, comprises a pre-heating roller 32 rather than a convex fixed surface 31 as shown in FIG. 3. It must be understood that also in the embodiment of FIGS. 2 to 4, a pre-heating roller 32 can be used in place of the fixed surface 31, or in combination therewith. Similarly, the springs 56 of the lightening system 54 (FIG. 5) can be used in the embodiment of FIGS. 2 to 4 in combination with the lightening system comprising the pneumatic piston-cylinder actuators 53.

It is understood that the drawing shows just one example, provided merely as a practical demonstration of the invention, which can vary in its forms and arrangements, without however departing from the scope of the concept underlying the invention. Any reference numbers in the appended claims are provided to facilitate reading of the claims with reference to the description and to the drawing, and do not limit the scope of protection represented by the claims.

What is claimed is:

1. A machine for bonding a smooth paper sheet to at least a corrugated paper sheet and forming a corrugated cardboard sheet, the machine comprising: a series of heated plates arranged according to a longitudinal cardboard advancement direction; above said heated plates, a plurality of pressure members, to press the paper sheets against said heated plates; between said heated plates and said pressure members, an endless flexible contact and advancement element, which is pressed by the pressure members against the paper sheets below, said endless flexible element being driven around at least one input guide member and at least one output guide member, wherein said input guide member is positioned above a sliding surface of the corrugated cardboard at a distance from said sliding surface such that said paper sheets are pressed together between said sliding surface and said endless flexible element at said input guide member, wherein guiding elements are arranged upstream of said input guide member of the sheets paper, said guiding elements defining a plurality of trajectories for advancing the paper sheets to be bonded, maintaining said paper sheets spaced apart from one another, wherein said guiding elements, said sliding surface and said input guide member are arranged such that said paper sheets are brought into mutual contact in the area of minimum distance between said input guide member and said sliding surface.

2. The machine as claimed in claim 1, wherein said input guide member defines the input point of an advancement space of the paper sheets delimited between said endless flexible element and said sliding surface.

3. The machine as claimed in claim 1, wherein said input guide member is movable to move towards said sliding surface and is stressed against said sliding surfaces to press on said sheets.

4. The machine as claimed in claim 1, wherein at least a lightening system is associated with said input guide member to discharge at least a part of the weight of the input guide member and reduce the force with which said input guide member presses on the paper sheets below.

5. The machine as claimed in claim 1, wherein said input guide member comprises a roller with an axis of rotation oriented substantially at 90° with respect to the longitudinal advancement direction of the paper sheets.

6. The machine as claimed in claim 1, wherein said input guide member is supported by at least one oscillating arm.

7. The machine as claimed in claim 6, wherein said input guide member is supported by a double oscillating arm.

8. The machine as claimed in claim 6, wherein the oscillating arm is pivoted about an oscillation axis positioned upstream of the input guide member with respect to the cardboard advancement direction.

9. The machine as claimed in claim 5, wherein the axis of said roller of the input guide member and the oscillation axis of said oscillating arm lie on a geometrical plane oriented approximately according to the bisector of an angle defined by two branches of the endless flexible element tangent to said roller.

10. The machine as claimed in claim 6, wherein said oscillating arm supports a plurality of pressure members acting on the endless flexible element down-stream of said input guide member.

11. The machine as claimed in claim 10, wherein said pressure members supported by said oscillating arm comprise pressure rollers, each supported by an auxiliary arm pivoted to said oscillating arm.

12. The machine as claimed in claim 1, wherein said sliding surface is defined by said heated plates.

13. The machine as claimed in claim 1, wherein said endless flexible element is driven around said input guide member for an angle of at least 90°, preferably at least 120° and even more preferably at least 150°.

14. A method for gluing at least a smooth paper sheet and a corrugated paper sheet comprising the steps of:
advancing said paper sheets along an advancement path in contact with a series of heated plates and an endless flexible contact and advancement element pressed against said paper sheets by a plurality of pressure members above, said endless flexible element being driven around at least an input guide member and an output guide member;
heating said paper sheets and holding said paper sheets pressed together while advancing said paper sheets along said advancement path to cause gluing thereof;
maintaining said paper sheets spaced apart until a mutual joining area, defined by said input guide member, in which area all the paper sheets are brought into mutual contact and joined together by pressing the paper sheets between said endless flexible element and a sliding surface below at said input guide member.
